(19) United States
(12) Patent Application Publication
(10) Pub. No.: US 2024/0136103 A1
(43) Pub. Date: Apr. 25, 2024

(54) PLANAR MAGNETIC ELEMENT AND MANUFACTURING METHOD THEREOF

(71) Applicant: Delta Electronics (Shanghai) Co.,Ltd., Shanghai (CN)

(72) Inventors: Teng LIU, Shanghai (CN); Jianxing DONG, Shanghai (CN); Xiaohu LI, Shanghai (CN); Liang WANG, Shanghai (CN); Lei CHEN, Shanghai (CN)

(21) Appl. No.: 18/360,839

(22) Filed: Jul. 27, 2023

(30) Foreign Application Priority Data
Oct. 20, 2022 (CN) 202211294715.3

(51) Int. Cl. H01F 27/02; H01F 27/24; H01F 27/32; H01F 41/12

(52) U.S. Cl. CPC H01F 27/022; H01F 27/24; H01F 27/327; H01F 41/127

(57) ABSTRACT

The present disclosure discloses a planar magnetic element and a manufacturing method thereof. The planar magnetic element includes: a housing, with an internal space; a core, accommodated in the internal space of the housing, and the core including at least one limb; at least one planar winding corresponding to the limb; and potting adhesive, filled in all air gaps in the internal space of the magnetic element, and blocking the clearance and creepage path between the planar winding and the core and/or between the two planar windings. The present disclosure may significantly reduce the volume of the magnetic element and greatly increase the partial discharge extinction voltage, thereby reducing the partial discharge risk of the magnetic element and improving the reliability. Moreover, the compact structure of the planar magnetic element is conducive to improving the power density of the module.

### CROSS-REFERENCE TO RELATED APPLICATIONS

This non-provisional application claims priority under 35 U.S.C. § 119(a) on Patent Application 202211294715.3 filed in P.R. China on Oct. 21, 2022, the entire contents of which are hereby incorporated by reference.

Some references, if any, which may include patents, patent applications and various publications, may be cited and discussed in the description of this disclosure. The citation and/or discussion of such references, if any, is provided merely to clarify the description of the present disclosure and is not an admission that any such reference is “prior art” to the disclosure described herein. All references listed, cited and/or discussed in this specification are incorporated herein by reference in their entireties and to the same extent as if each reference was individually incorporated by reference.

### BACKGROUND ART

### 1. Field of the Disclosure

The present disclosure relates to the technology of power electronics, in particular to a planar magnetic element and a manufacturing method thereof.

### 2. RELATED ART

In recent years, the rapid development of renewable energy technologies such as PV and wind power has promoted the gradual improvement of the voltage level of the micro grid system. The power electronic converter is used for grid connection of new energy, its reliability is the key factor to determine the stablility of the power grid system. However, with the continuous improvement of the voltage level of the power grid system, the isolation voltage borne by the auxiliary power in the power electronic converter is also increasing, leading to a significant rise in the failure rate. Therefore, it is critical to improve the reliability of the auxiliary power for the stablility of the power grid system.

The failure rate of switching devices and capacitors in the auxiliary power is low; the transformer, inductor and other magnetic elements are prone to insulation failure due to high insulation voltage level which may be several thousand volts. Therefore, the key to reduce the failure rate of the auxiliary power is to solve the insulation problem of magnetic elements and improve their reliability.

The insulation structure is one of the key factors affecting the reliability of magnetic elements. At present, the common insulation structures in the industry mainly include insulation tape, insulation skeleton, vacuum encapsulation, etc. The scheme of insulating tape and insulating skeleton is mostly used in low-voltage systems, because there is a small air gap between the winding tape layers or between two layers of skeletons, consequently to cause low insulation reliability in medium and high voltage systems; in the vacuum encapsulation structure, the bubbles inside the encapsulation material can be completely removed through the vacuum deaerating, ensuring the high reliability of the insulation structure; but in the encapsulation process, the fixing and forming of windings is a problem. Traditional vertical wound magnetic elements often need additional insulation skeleton to support the windings, which will lead to complex process, larger element volume and lower power density. The planar magnetic elements with PCB windings as an example can eliminate the steps of winding fixing and forming, and the windings can be produced automatically, which lead to low labor costs, simple process and good parameter consistency.

However, traditional PCB windings are mostly used in low-voltage fields. In PCB windings, the insulation cover layer (103′ in FIG. 1) covering the outer layer of printed copper foil (102a-1′, 102a-2′ in FIG. 1) is generally only tens of microns thick, so it cannot be regarded as solid insulation. Therefore, the insulation cover layer cannot block the clearance or creepage path between the copper foil in the PCB windings and other metal conductors in the magnetic elements (as shown in FIGS. 1 and 2). FIG. 1 shows the creepage path P′ between two traditional PCB windings. FIG. 2 is the structural diagram of the traditional low-voltage PCB planar magnetic element, in which the PCB winding 10′ is mostly clung to the core 20′, and there is the clearance or creepage path P′ between the copper foil in the PCB windings and the core in the magnetic element. However, due to the low voltage level, the insulation structure of the PCB winding itself have met the required safety distances. For example, the solid insulation distance D1′ and D2′ between the copper foils 102a-1′ and 102a-2′ on the upper layer PCB winding and the corresponding copper foils 102b-1′and 102b-2′ on the lower layer PCB winding in FIG. 1 have met the required safety distances.

When PCB windings are used in the medium voltage field, the insulation voltage up to several thousand volts requires a larger clearance and creepage distances; the risk of insulation failure also increases accordingly. Therefore, the application of PCB planar magnetic elements in the medium voltage field is mainly restricted by the large volume, low power density and low insulation reliability of magnetic elements in order to meet the safety distances required by the medium voltage system.

Therefore, it is urgent to propose a high reliability planar magnetic element and a manufacturing method thereof for medium voltage auxiliary power.

### SUMMARY OF THE INVENTION

The purpose of the present disclosure is to provide a planar magnetic element and a manufacturing method thereof, which can effectively solve at least one defect of the prior art.

To achieve the above purpose, the present disclosure provides a planar magnetic element, including: a housing with an internal space; a core, accommodated in the internal space of the housing, and the core including at least one limb; at least one planar winding corresponding to the limb; and potting adhesive, filled in all air gaps in the internal space, and blocking the clearance and creepage path between the planar winding and the core and/or between the two planar windings.

In some embodiments of the present disclosure, the core is a spliced core structure formed by splicing multiple core parts.

In some embodiments of the present disclosure, the spliced core structure includes an upper core and a lower core, and the upper core and the lower core are spliced to form a splicing part.

In some embodiments of the present disclosure, the splicing part is provided with a single air gap; or, the splicing part is provided with a plurality of air gaps distributed at intervals.

In some embodiments of the present disclosure, the plurality of air gaps is distributed at equal intervals.

In some embodiments of the present disclosure, the upper core and the lower core of the spliced core structure are directly spliced to form the splicing part and have the same potential; or, the splicing part includes an insulating material for electrical isolation, and the upper core and the lower core respectively on either sides of the insulating material have different potentials.

In some embodiments of the present disclosure, the core is a complete single core structure.

In some embodiments of the present disclosure, the planar winding is a spliced planar winding structure, which includes a first winding part and a second winding part located in the same plane, and the first winding part and the second winding part are connected by a winding lapping part.

In some embodiments of the present disclosure, the planar magnetic element is a planar inductor, wherein the at least one planar winding forms a single winding.

In some embodiments of the present disclosure, the single winding includes only one planar winding; or, the single winding includes multiple planar windings, and the planar windings are electrically connected in series, or in parallel, or in a series-parallel hybrid structure.

In some embodiments of the present disclosure, the planar magnetic element is a planar transformer, wherein at least two planar windings respectively form a primary winding and a secondary winding.

In some embodiments of the present disclosure, the primary winding thus formed includes only one primary planar winding; and/or, the secondary winding thus formed includes only one secondary planar winding; or, the primary winding thus formed includes multiple primary planar windings, and the multiple primary planar windings are electrically connected in series or in parallel; and/or, the secondary winding thus formed includes multiple secondary planar windings, and the multiple secondary planar windings are electrically connected in series, or in parallel, or in a series-parallel hybrid structure.

In some embodiments of the present disclosure, the primary winding thus formed and the secondary winding thus formed are longitudinally arranged in an orderly up-and-down structure, a sandwich structure, or a staggered structure. Wherein, with regard to the orderly up-and-down structure, the multiple primary planar windings forming the primary winding and the multiple planar windings forming the secondary winding are longitudinally arranged up and down. with regard to the sandwich structure, the multiple primary planar windings forming the primary winding are longitudinally arranged between any two of the multiple secondary planar windings forming the secondary winding; or, the multiple secondary planar windings forming the secondary winding are longitudinally arranged between any two of the multiple primary planar windings forming the primary winding. with regard to the staggered structure, the multiple primary planar windings forming the primary winding and the multiple planar windings forming the secondary winding are longitudinally staggered at intervals.

In some embodiments of the present disclosure, the primary winding thus formed and the secondary winding thus formed are arranged on the same limb, or arranged on different limbs separately.

In some embodiments of the present disclosure, the primary winding thus formed and/or the secondary winding thus formed are insulated from the corresponding limb, and there is a gap between the primary planar winding forming the primary winding and/or the secondary planar winding forming the secondary winding and the corresponding limb. Or, the primary winding thus formed or the secondary winding thus formed is equipotential with the core, wherein the primary planar winding forming the primary winding and/or the secondary planar winding forming the secondary winding is/are bonded with the corresponding limb.

In some embodiments of the present disclosure, the planar magnetic element further includes: at least one locating pin, throughout at least one locating hole on the planar winding; at least one insulating spacer, arranged between the two planar windings and/or between the planar winding and the core; wherein the longitudinal and transverse positions of the planar winding and/or the core in the internal space can be located by the locating pin.

In some embodiments of the present disclosure, the planar magnetic element further includes: a support limiting structure, arranged on an inner wall of the housing for locating the longitudinal and transverse positions of the planar winding and/or the core in the internal space.

To achieve the above purpose, the present disclosure also provides a manufacturing method for the planar magnetic element described above, includes the following steps: Step S11: locating pins are installed respectively throughout multiple locating holes of the planar winding at the bottom layer; Step S12: an insulating spacer is installed on the planar winding at the bottom layer, and then an upper layer of planar windings is placed; Step S13: the Step S12 is repeated until all of the planar windings are installed, and then the locating pins are welded and fixed to form a planar winding subassembly; Step S14: the planar winding subassembly is sleeved on the lower core, then put them into the housing together, and then the upper core is installed; Step S15: liquid potting adhesive is injected into the internal space of the housing to make it completely fill all the air gaps in the internal space, in order to block the clearance and creepage path between the planar winding and the upper core, between the planar winding and the lower core, and/or between the two planar windings, and then curing under predetermined curing conditions; Step S16: offcuts are treated after curing.

To achieve the above purpose, the present disclosure further provides a manufacturing method for the planar magnetic element described above, includes the following steps: Step S21: a housing with a support limiting structure is provided; Step S22: the lower core, planar winding and upper core are placed into the housing in sequence, and correspondingly fixed by the support limiting structure; Step S23: liquid potting adhesive is injected into the internal space of the housing to make it completely fill all the air gaps in the internal space, in order to block the clearance and creepage path between the planar winding and the upper core, between the planar winding and the lower core, and/or between the two planar windings, and then curing under predetermined curing conditions; Step S24: offcuts are treated after curing.

The present disclosure not only reduces the internal pollution level of the magnetic element, but also blocks the clearance and creepage path between the planar windings and the core, and between two planar windings by filling all air gaps in the magnetic element with potting adhesive.

The present disclosure not only significantly reduces the volume of the magnetic element, but also greatly increases the partial discharge extinction voltage, thereby reducing the partial discharge risk of the magnetic element and improving the reliability. In addition, the present disclosure is convenient for automatic production of windings by adopting planar windings (including but not limited to, for example, PCB windings). Moreover, the compact structure of the planar magnetic element is conducive to improving the power density of the module.

The present disclosure provides a planar magnetic element with high reliability, and optimizes the insulation structure and manufacturing method, which not only has no application precedent in the industry, but also provides a highly competitive insulation structure of medium voltage planar magnetic element for the industry.

Additional aspects and advantages of the present disclosure will be set forth in part in the following description, and will become apparent in part from the description, or may be learned through the practice of the present disclosure.

### BRIEF DESCRIPTION OF THE DRAWINGS

The above and other features and advantages of the present disclosure will become more apparent by describing the exemplary embodiments thereof in detail with reference to the drawings.

FIG. 1 is a schematic diagram of a creepage path between two traditional PCB windings;

FIG. 2 is a structural diagram of a traditional low-voltage PCB planar magnetic element;

FIG. 3A is a structural diagram of one typical embodiment of a planar magnetic element (such as an inductor) according to the present disclosure;

FIG. 3B is a structural diagram of the decomposed structure of a planar magnetic element as shown in FIG. 3A;

FIG. 3C is a top view of an assembled planar magnetic element as shown in FIG. 3B;

FIG. 4A is a structural diagram of another typical embodiment of the planar magnetic element (for example, as a transformer) according to the present disclosure;

FIG. 4B is a structural diagram of the decomposed structure of a planar magnetic element as shown in FIG. 4A;

FIG. 5 is a structural diagram of the deformed embodiment of a planar magnetic element according to the present disclosure;

FIG. 6 is a structural diagram of different winding forms in the planar magnetic element according to the present disclosure;

FIG. 7A, FIG. 7B and FIG. 7C respectively show that the planar magnetic element of the present disclosure is used as a planar transformer, and primary and secondary windings are longitudinally arranged in an orderly up-and-down structure, a sandwich structure, or a staggered structure;

FIGS. 8A and 8B respectively show that the planar magnetic element of the present disclosure is used as a planar transformer, and there are two different arrangements between the primary and secondary windings and the limb, in which FIG. 8A shows that the primary and secondary windings are arranged on the same limb, and FIG. 8B shows that the primary and secondary windings are arranged separately on different limbs;

FIG. 9 shows that the planar magnetic element according to the the present disclosure is used as a planar transformer, in which the primary winding or secondary winding is equipotential with the core;

FIG. 10 is a flow diagram of a manufacturing method for the planar magnetic element according to the present disclosure;

FIGS. 11A-11F respectively show state diagrams of different stages of the manufacturing method in FIG. 10;

FIG. 12 is a flow diagram of another manufacturing method for the planar magnetic element according to the present disclosure; and

FIGS. 13A-13D respectively show state diagrams of different stages of the manufacturing method in FIG. 12.

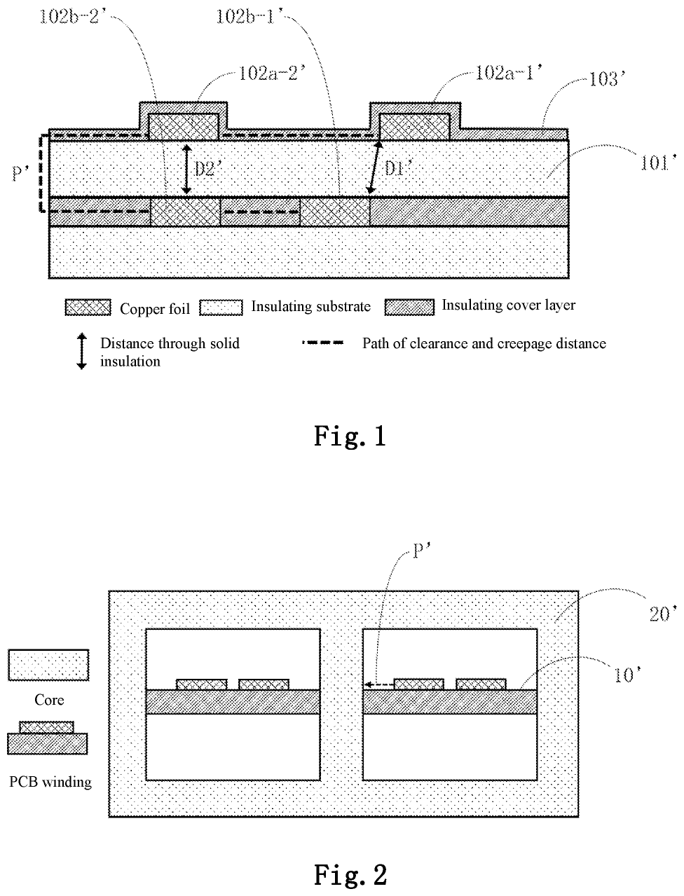

### DETAILED EMBODIMENTS

Exemplary embodiments will now be described more fully with reference to the accompanying drawing. However, the exemplary embodiments may be implemented in many forms and should not be construed as limited to the embodiments set forth herein. On the contrary, these exemplary embodiments are provided so that the present disclosure will be comprehensive and complete, and will the conception of exemplary embodiments will be fully conveyed to those skilled in the art. The same reference numerals in the drawings denote the same or similar structures, and thus detailed descriptions thereof will be omitted.

When introducing the elements/components/etc. described and/or illustrated herein, the terms “one”, “a”, “this”, “the” and “at least one” are used to indicate the existence of one or more elements/components/etc. The terms “include”, “comprise” and “provided with” are used to mean open inclusion and mean that there may be other elements/components/etc. in addition to the listed elements/components/etc. In addition, the terms “first”, “second” and the like in the claims are only used as marks, and are not numerical restrictions on their objects.

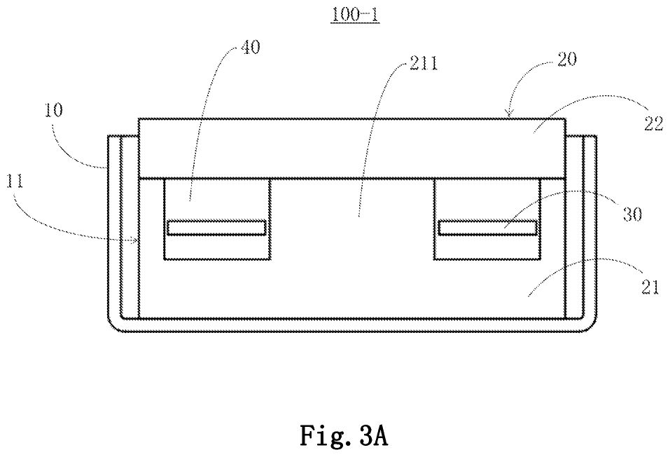

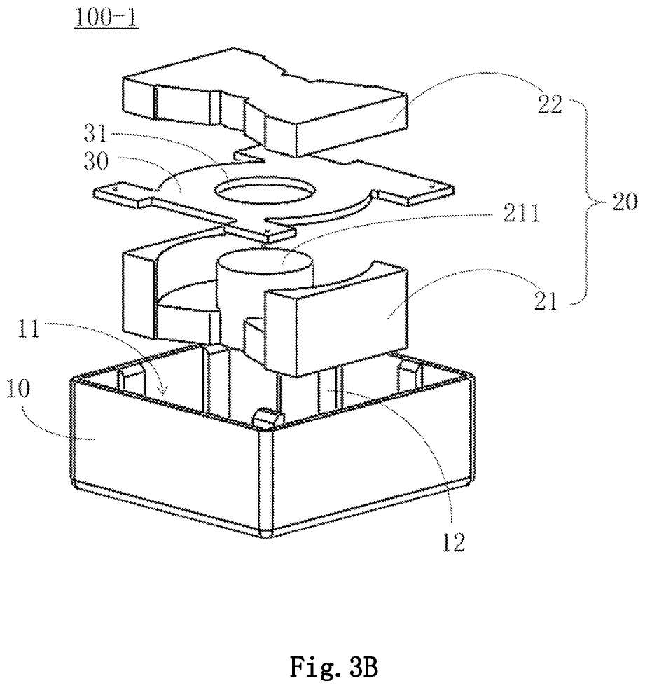

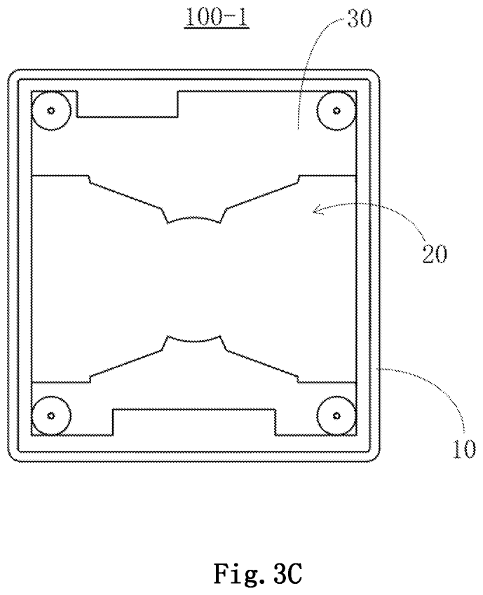

As shown in FIGS. 3A-3C, a typical embodiment of the planar magnetic element 100-1 of the present disclosure is shown, which mainly includes a housing 10, a core 20, at least one planar winding 30 and potting adhesive 40. The housing 10 has an internal space 11. The core 20 is accommodated in the internal space 11 of the housing 10, and at least includes one limb 211. The planar winding 30 is installed corresponding to the limb 211. All air gaps in the internal space 11 of the housing 10 are filled with the potting adhesive 40, thus forming a fully encapsulated structure. The potting adhesive 40 can block the clearance and creepage path between the planar winding 30 and the core 20, and/or between two planar windings 30 (for example, corresponding to the case of multiple planar windings).

In some embodiments of the present disclosure, the shape of the core 20, for example, can be any of EE type, EI type, UU type, UI type, PQ type, or ER type, but the present disclosure is not limited to this.

In some embodiments of the present disclosure, the core 20, for example, can be of a spliced core structure formed by splicing multiple core parts. As shown in FIG. 3A, the core 20 is formed by splicing two core parts, i.e., formed by splicing the lower core 21 and upper core 22, wherein the limb 211 is formed on the lower core 21. The planar winding 30 can be installed on the limb 211 through a mounting hole 31 thereon (as shown in FIG. 3B).

In some embodiments of the present disclosure, the material of the core 20 can be but is not limited to any of ferrite, amorphous, nanocrystalline, etc., to meet the different requirements of magnetic elements for magnetic properties, machinability, and cost. For the spliced core structure, the core material of each core part can be the same, or any combination of ferrite, amorphous, nanocrystalline and other materials.

In some embodiments of the present disclosure, for the spliced core structure, the splicing part formed by splicing two core parts can be air gap free, that is, the two core parts are in direct contact. Or, the splicing part formed by splicing two core parts can also have an air gap, that is, there is an air gap between the two core parts. The air gap can avoid magnetic saturation of the core at a high frequency, but it will increase magnetic leakage accordingly.

Furthermore, in the present disclosure, the splicing part may have a single air gap. Or, the splicing part may also be provided with a plurality of air gaps distributed at intervals, and the distance between these air gaps may be equal or unequal, which is not intended to limit the present disclosure. For example, a spliced core structure can be directly spliced from a lower first core part (such as the lower core 21 in FIG. 3A) and an upper second core part (such as the upper core 22 in FIG. 3A), wherein the splicing part formed on the left side can be air gap free, and the splicing part formed on the right side can be of segmented air gaps with multiple equal parts. However, it can be understood that, for the spliced core structure, the number of core parts and the structure of the splicing part (such as without or with the air gap) can be designed according to the actual needs, and the present disclosure is not limited to this.

For the spliced core structure, each core part can be directly spliced and have the same potential. Or, the splicing part of the spliced core structure can also include an insulating material for electrical isolation. For example, the splicing part formed by splicing two core parts can be provided with an insulating material for electrical isolation. The two core parts located on either sides of the insulating material may have different potentials.

In some embodiments of the present disclosure, the planar winding 30, for example, can be a PCB winding. The insulating substrate of the PCB winding can be, for example, an FR-4 printed board, a copper-clad substrate, or a direct copper bond (DCB) with better thermal conductivity. However, it can be understood that the PCB winding is not the only planar winding structure. In other embodiments of the present disclosure, the planar winding can also be a pie winding wound with flat enamelled wire, for example, it can be applied to occasions with higher requirements for current flow capacity; it can also be a copper sheet or copper foil winding, for example, it is mainly used for windings with low voltage and high current, or with fewer turns.

In some embodiments of the present disclosure, the core 20 is not a prerequisite component, and can be removed to form a coreless transformer, which is used for (wireless) non-contact energy or signal transmission. For example, the drive signal transmission transformer of power electronic switching device has a high isolation and withstand voltage level and strong resistance to common mode interference.

In some embodiments of the present disclosure, the housing 10 can be a part of the planar magnetic element, and can serve as a structural support or protection, as shown in the embodiments of FIGS. 3A-3C. However in other embodiments of the present disclosure, the housing 10 can also be a container for encapsulation in the manufacturing process of the planar magnetic element, and it can be removed through the demolding process upon completion of manufacturing.

In some embodiments of the present disclosure, the potting adhesive 40 can be made of materials with low hardness, low viscosity and good adhesion, for example, but it is not limited to AB two-component potting adhesive.

As shown in FIGS. 3A-3B, in some embodiments of the present disclosure, the planar magnetic element 100-1, for example, can be a planar inductor, wherein the at least one planar winding 30 can form a single winding, applied in the planar inductor. The single winding may include only one planar winding 30; or, the single winding can also include multiple planar windings 30, and the multiple planar windings 30 can be electrically connected in series, or in parallel, or in a series-parallel hybrid structure, in order to meet the requirements of different voltage, power levels. When the single winding includes multiple planar windings 30, these planar windings need to be separated to meet the insulation requirements.

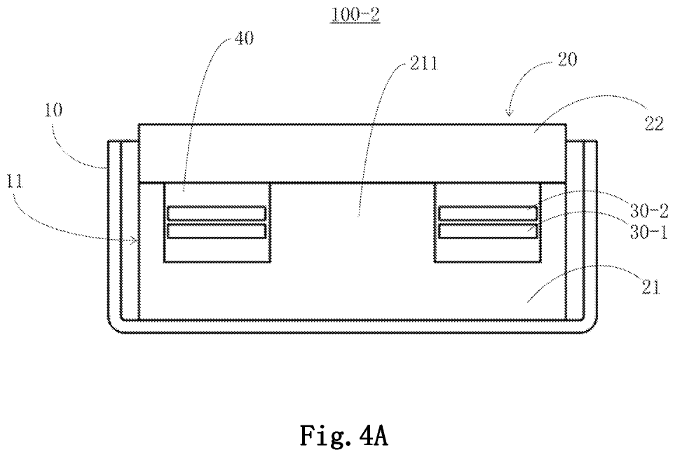

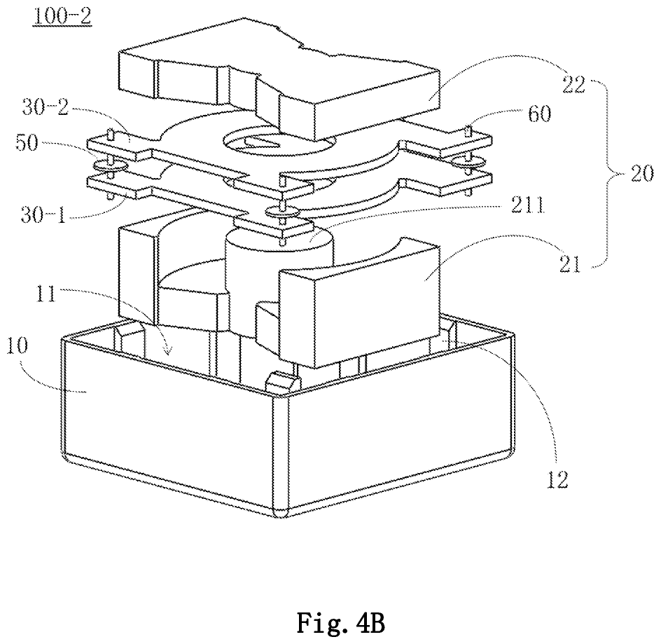

As shown in FIGS. 4A-4B, in some embodiments of the present disclosure, the planar magnetic element 100-1, for example, can be a planar transformer, wherein at least two planar windings 30-1, 30-2 can separately form a primary winding and a secondary winding of the planar transformer. The primary winding thus formed can include only one primary planar winding, and the secondary winding thus formed can also include only one secondary planar winding. Or, the primary winding thus formed can include multiple primary planar windings, and the multiple primary planar windings can be electrically connected in series or in parallel; the secondary winding thus formed can also include multiple secondary planar windings, and the multiple secondary planar windings can also be electrically connected in series, or in parallel, or in a series-parallel hybrid structure.

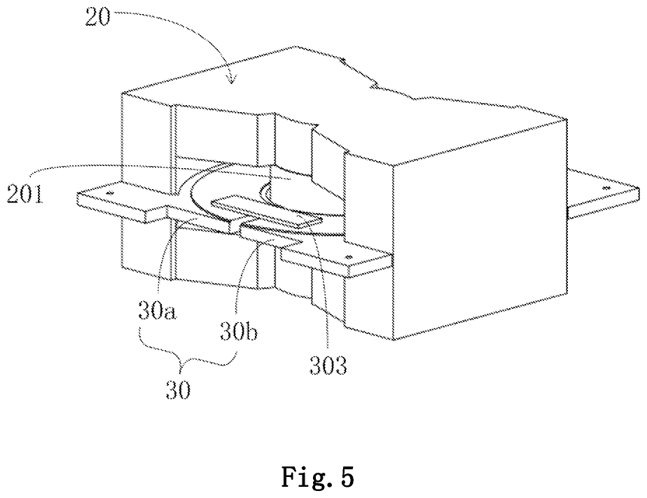

As shown in FIG. 5, in some embodiments of the present disclosure, the core 20 can also be a complete single core structure, applied in scenarios with high requirements for magnetic permeability. At this time, the planar winding 30 can preferably be a spliced planar winding, which can include, for example, a first winding part 30a and a second winding part 30b located in the same plane, and the first winding part 30a and the second winding part can be connected through a winding lapping part 303.

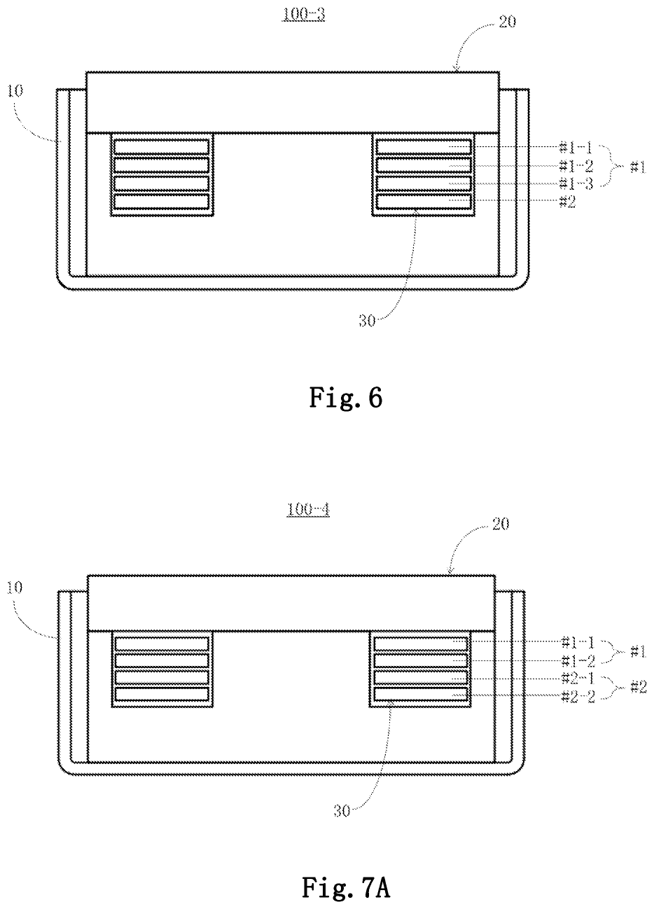

FIG. 6 shows a structure composed of different windings in a planar magnetic element 100-3. Each winding can contain only one planar winding 30, or multiple planar windings 30. For example, in the embodiment as shown in FIG. 6, winding #1 is composed of three planar windings #1-1, #1-2, and #1-3, and winding #2 is composed of one planar winding.

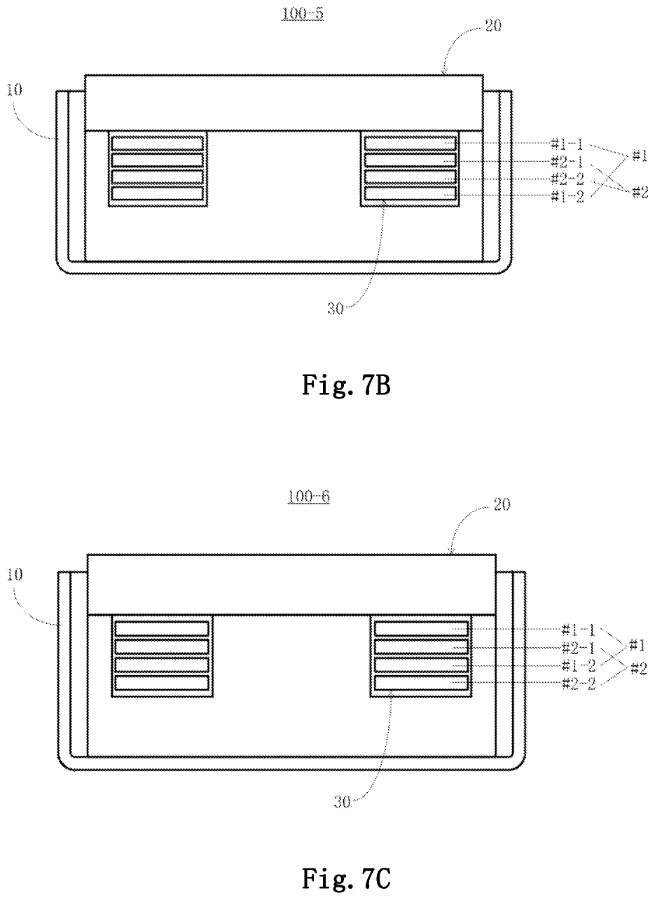

In some embodiments of the present disclosure, for the planar transformer, the primary winding thus formed and the secondary winding thus formed are longitudinally arranged in an orderly up-and-down structure (as shown in FIG. 7A), a sandwich structure (as shown in FIG. 7B), or a staggered structure (as shown in FIG. 7C). The leakage inductance is maximum when the windings are of the orderly up-and-down structure; the leakage inductance is reduced in the sandwich structure; the magnetic field coupling is the tightest in the staggered structure, so the leakage inductance is minimum.

With regard to the planar magnetic element 100-4 in an orderly up-and-down structure as shown in FIG. 7A, the multiple primary planar windings (for example including planar windings #1-1 and #1-2) forming the primary winding (for example winding #1) and the multiple secondary planar windings (for example including planar windings #2-1 and #2-2) forming the secondary winding (for example winding #2) are longitudinally arranged up and down, that is, the planar windings #1-1, #1-2, #2-1 and #2-2 are arranged from up to down in order. Of course, it can be understood that in other embodiments, the secondary winding can also be formed by the winding #1, and the primary winding can also be formed by the winding #2, which is not intended to limit the present disclosure.

With regard to the planar magnetic element 100-5 in a sandwich structure as shown in FIG. 7B, the multiple primary planar windings (for example including planar windings #2-1 and #2-2) forming the primary winding (for example winding #2) are longitudinally arranged between any two of the multiple secondary planar windings (for example including planar windings #1-1 and #1-2) forming the secondary winding (for example winding #1), that is, the planar windings #1-1, #2-1, #2-2 and #1-2 are arranged from up to down in order. Of course, it can be understood that in other embodiments, the primary winding can also be formed by the winding #1, and the secondary winding can also be formed by the winding #2, which is not intended to limit the present disclosure.

With regard to the planar magnetic element 100-6 in a staggered structure as shown in FIG. 7C, the multiple primary planar windings (for example including planar windings #1-1 and #1-2) forming the primary winding (for example winding #1) and the multiple secondary planar windings (for example including planar windings #2-1 and #2-2) forming the secondary winding (for example winding #2) are longitudinally arranged up and down, that is, the planar windings #1-1, #2-1, #1-2 and #2-2 are arranged from up to down in order. Of course, it can be understood that in other embodiments, the secondary winding can also be formed by the winding #1, and the primary winding can also be formed by the winding #2, which is not intended to limit the present disclosure.

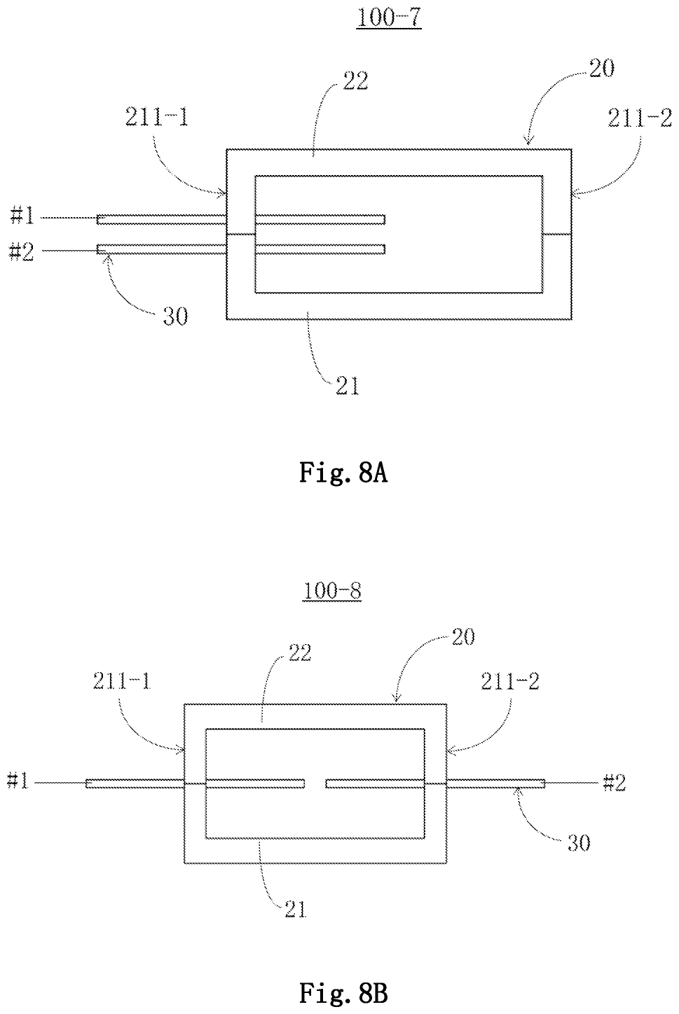

In some embodiments of the present disclosure, for the planar transformer, the primary winding thus formed and the secondary winding thus formed can be arranged on the same limb (as shown in FIG. 8A), or arranged on different limbs separately (as shown in FIG. 8B). For example, as shown in FIG. 8A, in the planar magnetic element 100-7, the core 20, for example, is formed by splicing the lower core 21 and the upper core 22, and a first limb 211-1 on the left side and a second limb 211-2 on the right side are formed, while the windings #1, #2 are both arranged on the first limb 211-1. The windings #1, #2, for example, can be used as the primary winding and the secondary winding of the planar transformer. The arrangement structure as shown in FIG. 8A can provide a tightly coupled magnetic field, thus obtaining a small leakage inductance; the planar transformer of this arrangement structure covers a small area, but is higher. As shown in FIG. 8B, unlike the embodiment as shown in FIG. 8A, in the planar magnetic element 100-8, windings #1 and #2 are arranged on different limbs, such as separately arranged on the first limb 211-1 and the second limb 211-2. The arrangement structure as shown in FIG. 8B can obtain a more flat structure; but the planar transformer of this arrangement structure will lead to high leakage inductance because of the long distance between the high and low voltage windings.

In some embodiments of the present disclosure, for the planar transformer, the primary winding thus formed and/or the secondary winding thus formed are insulated from the corresponding limb, and there is a gap between the primary planar winding forming the primary winding and/or the secondary planar winding forming the secondary winding and the corresponding limb, i.e., far away from the corresponding limb. As shown in FIGS. 3A and 3B, the planar winding 30, for example, can be a PCB winding, and can be used for forming the primary winding or secondary winding. The PCB board corresponding to the planar winding 30 is far away from the limb 211, that is, there is a gap between the mounting hole 31 on the planar winding 30 and the limb 211, and this gap can be filled with potting adhesive 40.

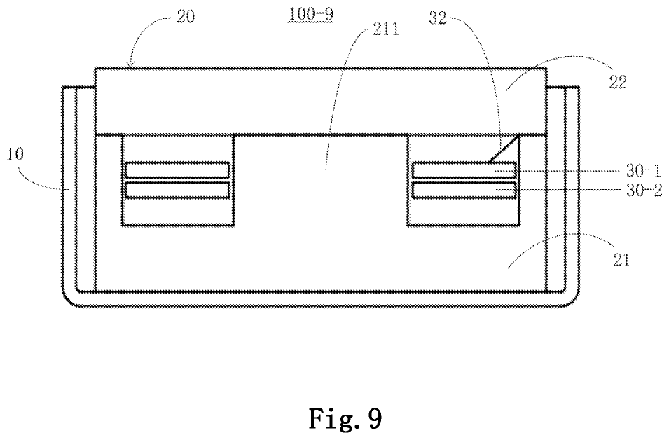

In some embodiments of the present disclosure, for the planar transformer, the primary winding thus formed or the secondary winding thus formed can be equipotential with the core, in which the primary planar winding forming the primary winding and/or the secondary planar winding forming the secondary winding is bonded with the corresponding limb. The equipotential connection mode can be but is not limited to welding wire/copper sheet. As shown in FIG. 9, in the planar magnetic element 100-9, the planar winding 30-1 is equipotential with the core 20 (which can be realized by connecting the planar winding 30-1 with the core 20 through the wire 32, for example). At this time, the planar winding 30-1 can be bonded with the core 20, and can block the creepage path between the planar winding 30-1 and other planar windings (for example the planar winding 30-2). At the same time, the core with fixed potential can improve electromagnetic interference.

In the present disclosure, the core can be equipotential with the primary and secondary windings of the winding respectively, can also be connected to the neutral point potential of the winding, and can also be connected to some specific potentials in the winding, which is not intended to limit the present disclosure.

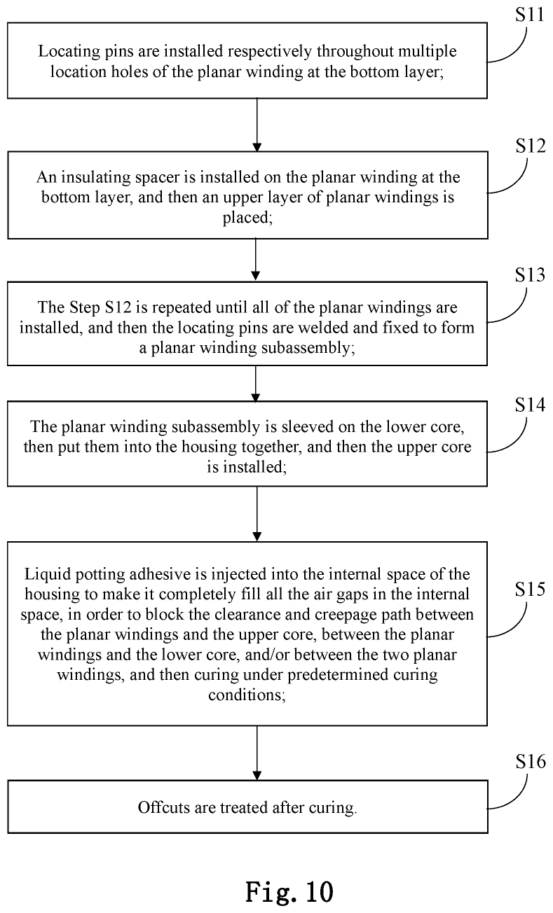

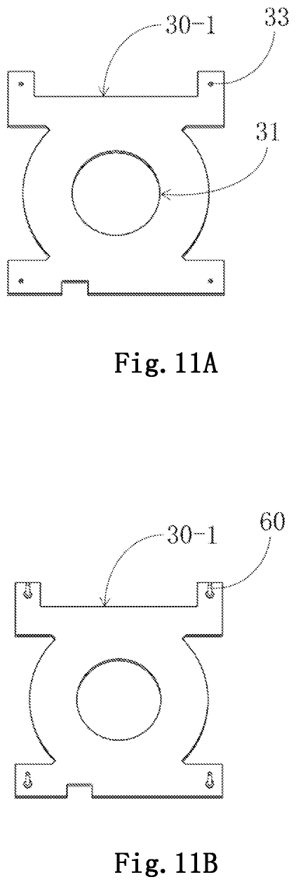

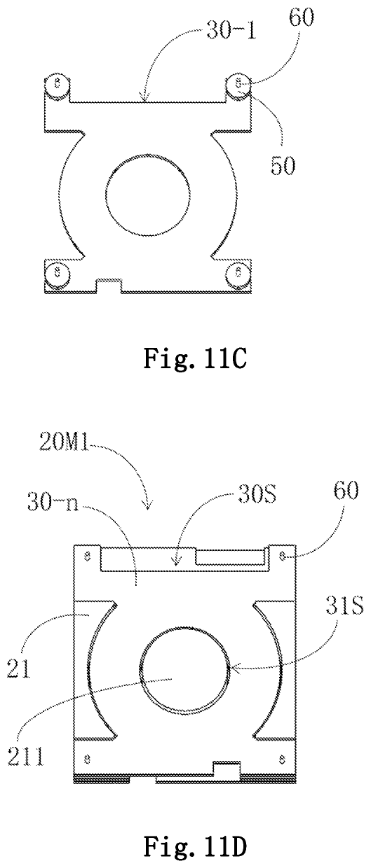

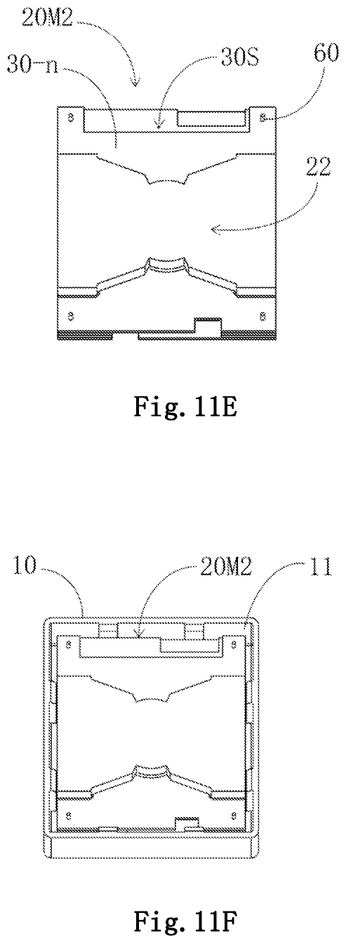

FIG. 10 shows the flow of a manufacturing method for the planar magnetic element of the present disclosure. FIGS. 11A-11F respectively show the states of different stages of the manufacturing method in FIG. 10.

As shown in FIG. 10, with reference to FIGS. 11A-11F, a manufacturing method for the planar magnetic element of the present disclosure mainly includes the following steps S11 to S16:

Step S11: locating pins are installed respectively throughout multiple location holes of the planar winding at the bottom layer. For example, the locating pins 60 can be installed in the location holes 33 at the four corners of the planar winding 30-1 at the bottom layer, as shown in FIG. 11A and FIG. 11B, which respectively show the structures of the planar winding 30-1 at the bottom layer before and after the locating pins are installed.

Step S12: an insulating spacer is installed on the planar winding at the bottom layer, and then an upper layer of planar windings is placed. For example, an insulating spacer 50 can be installed on the planar winding 30-1 at the bottom layer through the locating pin 60, as shown in FIG. 11C, and then an upper layer of planar windings can be placed on the structure as shown in FIG. 11C. In the present disclosure, the multiple planar windings can be located in the longitudinal space by means of the locating pin, and two planar windings can be electrically isolated by the insulating spacer.

Step S13: the Step S12 is repeated until all of the planar windings are installed, and then the locating pins are welded and fixed to form a planar winding subassembly. The planar winding subassembly 30S thus formed, for example, is as shown in FIG. 11D. For example, n planar windings can be stacked and installed through the location pin 60. The planar windings 30-n at the top layer are located at the uppermost, and the mounting holes of the n planar windings correspondingly form a through-hole structure 31S.

Step S14: the planar winding subassembly is sleeved on the lower core, then put them into the housing together, and the upper core is installed. The planar winding structure 30S, for example, is sleeved on the limb 211 of the lower core 21 through the through-hole structure 31S, and a first assembly 20M1 is formed after the sleeving, as shown in FIG. 11D. As shown in FIG. 11E, the first assembly 20M1 can be installed with an upper core 22 to form a second assembly 20M2. Then, as shown in FIG. 11F, the second assembly 20M2 is placed into the housing 10. Of course, it can be understood that in other embodiments, the first assembly 20M1 can also be put into the housing 10, and then the core 22 can be installed, which is not intended to limit the present disclosure. In the present disclosure, the upper core 22 and the planar windings 30-n at the top layer can also be electrically isolated by insulating spacers.

Step S15: liquid potting adhesive is injected into the internal space of the housing to make it completely fill all the air gaps in the internal space, in order to block the clearance and creepage path between the planar windings and the upper core, between the planar windings and the lower core, and/or between the two planar windings, and complete curing under predetermined curing conditions. For example, in the structure as shown in FIG. 11F, potting adhesive can be filled in the internal space 11 of the housing 10 to fill all the air gaps in the internal space, so as to block the clearance and creepage path between the planar winding and the core, and between two planar windings. The predetermined curing conditions may include, for example, specified vacuum degree, time and other curing conditions.

Step S16: Offcuts are treated after curing. After treatment, the finished products of planar magnetic elements meeting the requirements can be finally obtained.

In some embodiments of the present disclosure, as shown in FIGS. 11C and 11D, the planar magnetic element of the present disclosure may also include a locating pin 60 and a insulating spacer 50, so that the longitudinal and transverse positions of the planar winding and/or core can be located in the internal space through the locating pin 60. The locating pin 60 can penetrate the locating hole 33 on the planar winding (see FIG. 11A). The insulating spacer 50 may be placed between two planar windings, and/or between the planar winding and the core. As shown with reference to FIG. 3B, the inner wall of the internal space 11 of the housing 10 can also be provided with a support and limit structure, for example, including but not limited to the limit rib 12, which can limit the transverse position of the second assembly 20M2 in the internal space, for example.

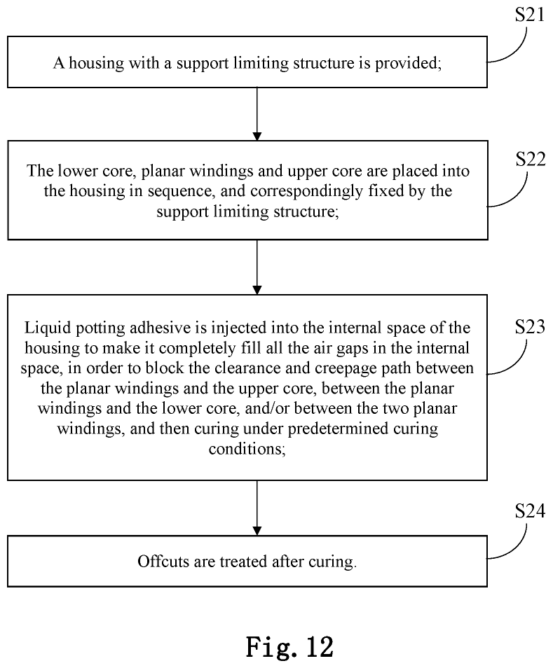

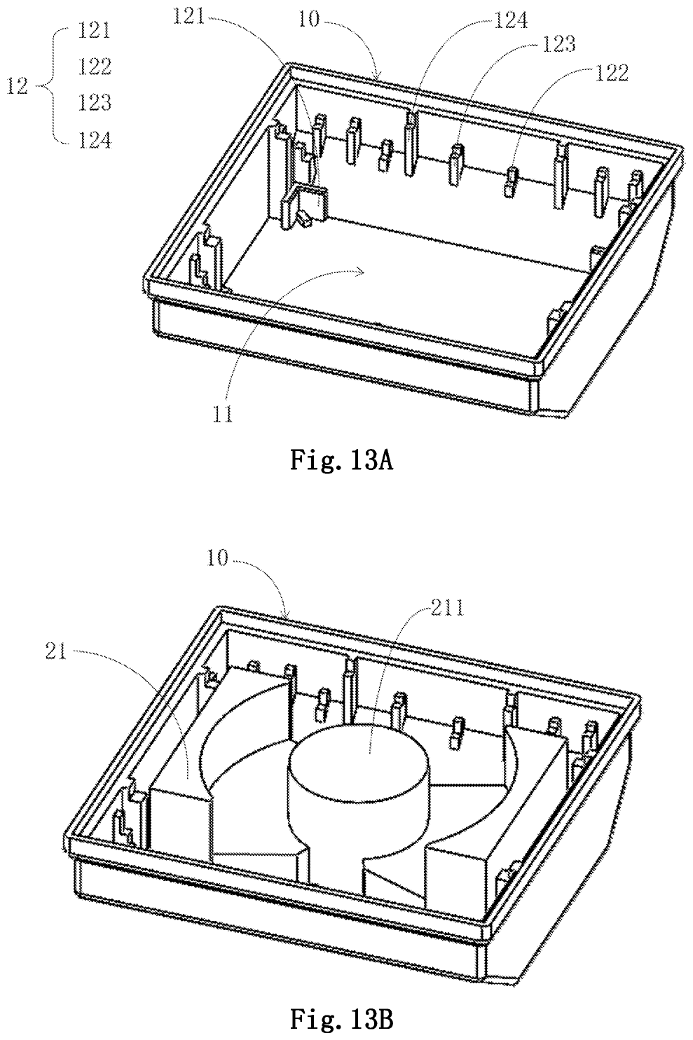

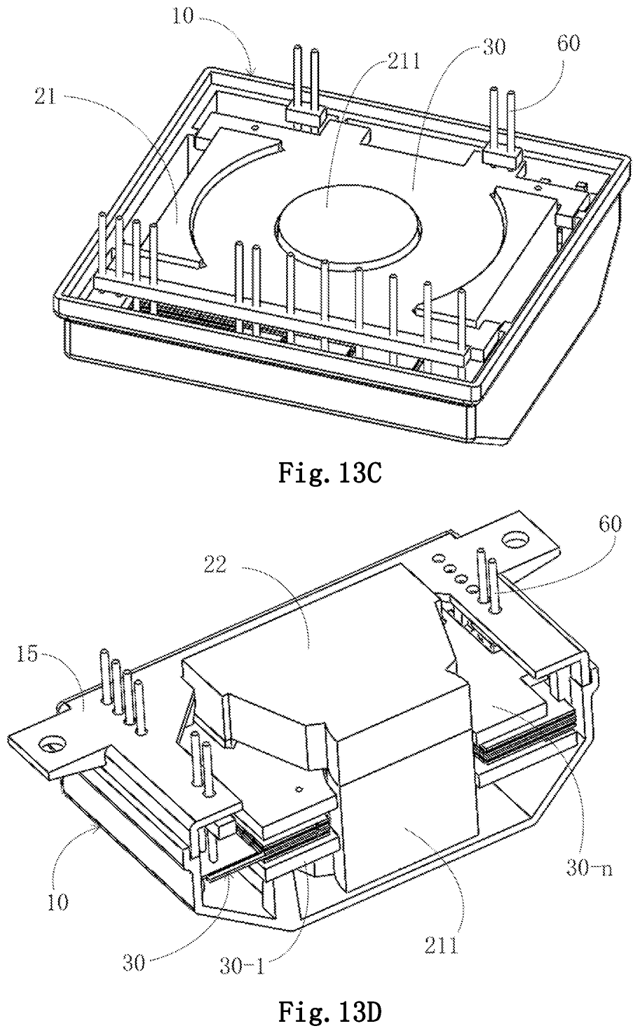

FIG. 12 shows the flow of another manufacturing method for the planar magnetic element of the present disclosure. FIGS. 13A-13D respectively show the state diagrams of different stages of the manufacturing method in FIG. 12.

As shown in FIG. 12, with reference to FIGS. 13A-13D, another manufacturing method for the planar magnetic element of the present disclosure mainly comprises the following steps S21 to S24:

Step S21: a housing with a support limiting structure is provided. As shown in FIG. 13A, the inner wall of the internal space 11 of the provided housing 10 can form a support limiting structure 12, which includes, for example, but is not limited to, a first support limiting structure 121 used for supporting and limiting the longitudinal and transverse positions of the lower core 21 (see FIG. 13B), a second support limiting structure 122, a third support limiting structure 123 and a fourth support limiting structure 124 used for supporting and limiting the longitudinal and transverse positions of the planar winding 30 (see FIG. 13C), wherein, the second support limiting structure 122, the third supporting limit structure 123 and the fourth support limiting structure 124 have different heights in the longitudinal position, so that the longitudinal height of the planar winding installed thereon can be limited.

Step S22: the lower core, planar winding and upper core are placed into the housing in sequence, and correspondingly fixed for limiting and assembled through the support limiting structure. FIG. 13B shows the structure after the lower core 21 is placed into the housing 10, wherein the lower core can be fixed and assembled through the first support limiting structure 121 in FIG. 13A. FIG. 13C shows the structure after the planar winding 30 is placed into the housing 10, wherein the planar winding 30 is installed on the limb 211 of the lower core 21, and fixed and assembled through the second support limiting structure 122, the third support limiting structure 123 and the fourth support limiting structure 124 in FIG. 13A. FIG. 13D shows the structure of the upper core 22 placed into the housing 10, and shows the planar winding structure after the assembly of multiple planar windings 30, comprising planar windings 30-1 at a bottom layer and planar windings 30-n at a top layer. FIG. 13D also shows the structure in which a cover 15 is assembled on the housing 10.

Step S23: liquid potting adhesive is injected into the internal space of the housing to make it completely fill all the air gaps in the internal space, in order to block the clearance and creepage path between the planar windings and the upper core, between the planar windings and the lower core, and/or between the two planar windings, and complete curing under predetermined curing conditions. For example, in the structure as shown in FIG. 13D, potting adhesive can be filled in the internal space of the housing 10 to fill all the air gaps in the internal space, so as to block the clearance and creepage path between the planar windings and the core, and between planar windings. The predetermined curing conditions may include, for example, specified vacuum degree, time and other curing conditions.

Step S24: Offcuts are treated after curing. After treatment, the finished products of planar magnetic elements meeting the requirements can be finally obtained.

The difference between the manufacturing methods as shown in FIGS. 12-13D and FIGS. 10-11F is that the housing 10 used in the manufacturing methods shown in FIGS. 12-13D is provided with a support limiting structure 12 for fixing and assembling the core and planar winding, without additional locating support accessories.

In some embodiments of the present disclosure, as shown in FIG. 13A, the planar magnetic element of the present disclosure may also include a support limiting structure 12, used for locating the longitudinal and transverse positions of the planar winding and/or core in the internal space.

In some other embodiments, preferably, as shown in FIG. 13C and FIG. 13D, the present disclosure can also further fix and assemble multiple planar windings 30 through locating pins 40, which is not intended to limit the present disclosure.

The present disclosure not only reduces the internal pollution level of the magnetic element, but also blocks the clearance and creepage path between the planar winding and the core, and between planar windings through filling all air gaps in the magnetic element with potting adhesive.

The present disclosure not only significantly reduces the volume of the magnetic element, but also greatly increases the partial discharge extinction voltage, thereby reducing the partial discharge risk of the magnetic element and improving the reliability. In addition, the present disclosure is convenient for automatic production of windings by adopting planar windings. Moreover, the compact structure of the planar magnetic element is conducive to improving the power density of the module.

Exemplary embodiments of the present disclosure have been specifically shown and described above. It should be understood that the present disclosure is not limited to the disclosed embodiments. On the contrary, the present disclosure is intended to cover various modifications and equivalent arrangements comprised in the spirit and scope of the appended claims.

What is claimed is:

1. A planar magnetic element, comprising:
a housing, with an internal space;
a core, accommodated in the internal space of the housing, and the core comprising at least one limb;
at least one planar winding corresponding to the limb; and
potting adhesive, filled in all air gaps in the internal space, and blocking the clearance and creepage path between the planar winding and the core and/or between the two planar windings.

2. The planar magnetic element according to claim 1, wherein,
the core is of a spliced core structure formed by splicing multiple core parts.

3. The planar magnetic element according to claim 2, wherein the spliced core structure comprises an upper core and a lower core, and the upper core and the lower core are spliced to form a splicing part.

4. The planar magnetic element according to claim 3, wherein,
the splicing part is provided with a single air gap; or,
the splicing part is provided with a plurality of air gaps distributed at intervals.

5. The planar magnetic element according to claim 4, wherein the plurality of air gaps is distributed at equal intervals.

6. The planar magnetic element according to claim 3, wherein,
the upper core and the lower core of the spliced core structure are directly spliced to form the splicing part and have the same potential; or,
the splicing part includes an insulating material for electrical isolation, and the upper core and the lower core respectively on either sides of the insulating material have different potentials.

7. The planar magnetic element according to claim 1, wherein
the core is a complete single core structure.

8. The planar magnetic element according to claim 7, wherein,
the planar winding comprises a spliced planar winding, which comprises a first winding part and a second winding part located in the same plane, and the first winding part and the second winding part are connected by a winding lapping part.

9. The planar magnetic element according to claim 1, wherein the planar magnetic element is a planar inductor, wherein the at least one planar winding forms a single winding.

10. The planar magnetic element according to claim 9, wherein,
the single winding includes only one planar winding; or,
the single winding includes multiple planar windings, and the multiple planar windings are electrically connected in series, or in parallel, or in a series-parallel hybrid structure.

11. The planar magnetic element according to claim 1, the planar magnetic element is a planar transformer, wherein at least two planar windings respectively form a primary winding and a secondary winding.

12. The planar magnetic element according to claim 11, wherein,
the primary winding thus formed includes only one primary planar winding; and/or, the secondary winding thus formed includes only one secondary planar winding; or,
the primary winding thus formed includes multiple primary planar windings, and the multiple primary planar windings are electrically connected in series or in parallel; and/or, the secondary winding thus formed includes multiple secondary planar windings, and the multiple secondary planar windings are electrically connected in series, or in parallel, or in a series-parallel hybrid structure.

13. The planar magnetic element according to claim 12, wherein the primary winding thus formed and the secondary winding thus formed are longitudinally arranged in an orderly up-and-down structure, a sandwich structure, or a staggered structure, wherein,
with regard to the orderly up-and-down structure, the multiple primary planar windings forming the primary winding and the multiple planar windings forming the secondary winding are longitudinally arranged up and down;
with regard to the sandwich structure, the multiple primary planar windings forming the primary winding are longitudinally arranged between any two of the multiple secondary planar windings forming the secondary winding; or, the multiple secondary planar windings forming the secondary winding are longitudinally arranged between any two of the multiple primary planar windings forming the primary winding;
with regard to the staggered structure, the multiple primary planar windings forming the primary winding and the multiple planar windings forming the secondary winding are longitudinally staggered at intervals.

14. The planar magnetic element according to claim 11, wherein the primary winding thus formed and the secondary winding thus formed are arranged on the same limb, or arranged on different limbs separately.

15. The planar magnetic element according to claim 11, wherein,
the primary winding thus formed and/or the secondary winding thus formed are insulated from the corresponding limb, and there is a gap between the primary planar winding forming the primary winding and/or the secondary planar winding forming the secondary winding and the corresponding limb; or,
the primary winding thus formed or the secondary winding thus formed is equipotential to the core, wherein the primary planar winding forming the primary winding and/or the secondary planar winding forming the secondary winding is/are bonded with the corresponding limb.

16. The planar magnetic element according to claim 3, comprising:
At least one locating pin, throughout at least one locating hole on the planar winding;
at least one insulating spacer, arranged between the two planar windings and/or between the planar winding and the core;
wherein the longitudinal and transverse positions of the planar winding and/or the core in the internal space can be located by the locating pin.

17. The planar magnetic element according to claim 3, comprising:
a support limiting structure, arranged on an inner wall of the housing for locating the longitudinal and transverse positions of the planar winding and/or the core in the internal space.

18. A manufacturing method for the planar magnetic element according to claim 16, comprising the following steps:
Step S11: locating pins are installed respectively throughout multiple locating holes of the planar winding at the bottom layer;
Step S12: an insulating spacer is installed on the planar winding at the bottom layer, and then an upper layer of planar windings is placed;
Step S13: the Step S12 is repeated until all of the planar windings are installed, and then the locating pins are welded and fixed to form a planar winding subassembly;
Step S14: the planar winding subassembly is sleeved on the lower core, then put them into the housing together, and the upper core is installed;
Step S15: liquid potting adhesive is injected into the internal space of the housing to make it completely fill all the air gaps in the internal space, in order to block the clearance and creepage path between the planar winding and the upper core, between the planar winding and the lower core, and/or between the two planar windings, and complete curing under predetermined curing conditions;
Step S16: offcuts are treated after curing.

19. A manufacturing method for the planar magnetic element according to claim 17, comprising the following steps:
Step S21: a housing with a support limiting structure is provided;
Step S22: the lower core, planar winding and upper core are placed into the housing in sequence, and correspondingly fixed by the support limiting structure;
Step S23: liquid potting adhesive is injected into the internal space of the housing to make it completely fill all the air gaps in the internal space, in order to block the clearance and creepage path between the planar winding and the upper core, between the planar winding and the lower core, and/or between the two planar windings, and then curing under predetermined curing conditions;
Step S24: offcuts are treated after curing.
